(19) United States
(12) Patent Application Publication
(10) Pub. No.: US 2026/0079064 A1
(43) Pub. Date: Mar. 19, 2026

(54) SYSTEMS AND METHODS FOR INSPECTING STRUCTURAL INTEGRITY OF BATTERY PACK

(71) Applicant: GM GLOBAL TECHNOLOGY OPERATIONS LLC, Detroit, MI (US)

(72) Inventors: Hassan Ghassemi-Armaki, Northville, MI (US); Blair E. CARLSON, Ann Arbor, MI (US); Ranajit GHOSH, Vernon Hills, IL (US); Ravi MAHESHWARI, Warren, MI (US)

(21) Appl. No.: 18/888,718

(22) Filed: Sep. 18, 2024

(51) Int. Cl. G01M 3/04; B25J 19/02; H01M 10/42

(52) U.S. Cl. CPC G01M 3/04; B25J 19/02; H01M 10/4228; H01M 10/4285

(57) ABSTRACT

A system configured to assess structural integrity of a battery pack component. The system includes: a tub configured to receive the battery pack component therein; a cover configured to sit on the tub and the battery pack component within the tub, and form a seal against both the tub and the battery pack component, thereby defining a reservoir between the tub, the cover, and the battery pack component; a pump configured to pump a gas into the reservoir through an inlet at the tub; and a sensor configured to detect a leak of the gas through the battery pack component from the reservoir, the leak corresponding to an area of the battery pack component having structural irregularities.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for inspecting structural integrity of a battery pack.

Battery cells are used to power a wide variety of devices and systems. For example, battery cells are power sources for battery electric vehicles (BEVs), plug-in hybrid electric vehicles (PHEVs), and hybrid electric vehicles (HEVs). Various types of battery cells may be used, such as prismatic battery cells, for example. The battery cells are packaged in battery packs, which include a battery tray and a cover. The battery pack is installed in a vehicle, for example, or at any suitable installation site of a non-vehicular application. Battery pack manufacturing processes include quality control checks to ensure structural integrity of the battery tray and the cover.

### SUMMARY

The present disclosure provides for, in various features, a system configured to assess structural integrity of a battery pack component. The system includes: a tub configured to receive the battery pack component therein; a cover configured to sit on the tub and the battery pack component within the tub, and form a seal against both the tub and the battery pack component, thereby defining a reservoir between the tub, the cover, and the battery pack component; a pump configured to pump a gas into the reservoir through an inlet at the tub; and a sensor configured to detect a leak of the gas through the battery pack component from the reservoir, the leak corresponding to an area of the battery pack component having structural irregularities.

In further features, the battery pack component includes at least one of a battery back tray and a battery pack cover.

In further features, the system includes clamps configured to clamp the cover against both the tub and the battery pack component.

In further features, the seal is an air-tight seal formed between the cover and each of a tub wall of the tub and a battery pack flange of the battery pack component.

In further features, the gas includes carbon dioxide.

In further features, a vacuum pump is configured to draw air out from within the reservoir prior to pumping the gas into the reservoir.

In further features, a portion of the reservoir is defined beneath the battery pack component between a bottom surface of the battery pack component and a base of the tub.

In further features, the sensor includes an infrared camera.

In further features, the infrared camera includes a filter configured to block infrared radiation outside of a wavelength of 4-5µm.

In further features, a heating element is configured to heat an inner surface of a cover flange of the cover, the inner surface painted a dark color, to configure the inner surface as a radiation backplate for the infrared camera.

In further features, the infrared camera is mounted to a first robot arm, the system further including a heated backplate mounted to a second robot arm.

In further features, the heated backplate is configured to be heated to within a range of 10°C-30°C above ambient temperature.

In further features, a control module is configured to control the sensor and control a robot arm configured to move the sensor about the battery pack component to perform a moving scan of the battery pack component for the leak of the gas, and to perform a stationary scan of the battery pack component for the leak of the gas after the leak is initially identified by the moving scan.

The present disclosure also includes, in various features, a system configured to assess structural integrity of a battery pack component. The system includes: a tub configured to receive the battery pack component therein; a cover configured to sit on the tub and the battery pack component seated within the tub, and form a seal against both the tub and the battery pack component, thereby defining a reservoir between the tub, the cover, and the battery pack component; a pump configured to pump a gas into the reservoir through an inlet at the tub; a sensor configured to detect a leak of the gas through the battery pack component from the reservoir, the leak corresponding to an area of the battery pack component having structural irregularities; a robotic arm configured to move the sensor about the battery pack component to detect the leak; and a control module configured to move the robotic arm and operate the sensor to perform a moving scan of the battery pack component and, upon identifying a suspected leak with the moving scan, operate the robotic arm and the sensor to perform a stationary scan of the suspected leak to determine whether the suspected leak is an actual leak of the gas through the battery pack component from the reservoir.

In further features, the sensor includes an infrared camera; the robotic arm is a first robotic arm, the system further including a second robotic arm configured to move a radiation backplate; and the control module is further configured to move the first robotic arm in tandem with the second robotic arm so that the infrared camera faces the radiation backplate.

In further features, the system includes a heating element configured to heat an inner surface of a cover flange of the cover, the inner surface painted a dark color, to configure the inner surface as a radiation backplate for the sensor configured as an infrared camera.

In further features, the battery pack component includes at least one of a battery pack tray and a battery pack cover.

The present disclosure further includes, in various features, a method for assessing structural integrity of a battery pack component. The method includes: positioning the battery pack component within a tub fixture; clamping a cover onto the tub fixture and the battery pack component seated within the tub fixture to form a seal between the cover and each of the tub fixture and the battery pack component, thereby defining a reservoir between the tub fixture, the cover, and the battery pack component; generating a vacuum that draws air out from within the reservoir; pumping a gas into the reservoir; and moving a robotic arm and operating a sensor to perform a moving scan of the battery pack component and, upon identifying a suspected leak in the battery pack component of gas through the battery pack component from the reservoir, operating the robotic arm and the sensor to perform a stationary scan of the suspected leak to determine whether the suspected leak is an actual leak of the gas through the battery pack component from the reservoir.

In further features, the sensor is an infrared camera and the robotic arm is a first robotic arm, the method further includes moving a second robotic arm holding a radiation backplate in tandem with the first robotic arm such that the infrared camera faces the radiation backplate.

In further features, the method includes heating an inner surface of a cover flange of the cover with a heating element, the inner surface painted a dark color, to configure the inner surface as a radiation backplate for the sensor configured as an infrared camera.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a system in accordance with the present disclosure configured to assess structural integrity of a battery tray of a battery pack;

FIG. 2 is a perspective view of a battery tray seated in a tub of the system of FIG. 1;

FIG. 3. is a perspective view of the battery tray seated in the tub with a cover clamped onto the battery tray and the tub, and robotic arms configured to move sensor components for assessing structural integrity of the battery tray;

FIG. 4 is a perspective view of an area of the battery tray and the cover clamped to the battery tray;

FIG. 5 is a cross-sectional view taken along line 5-5 of FIG. 3;

FIG. 6 illustrates an exemplary method in accordance with the present disclosure for assessing structural integrity of a battery tray; and

FIG. 7 illustrates a system in accordance with the present disclosure configured to assess structural ifntegrity of a battery pack cover.

In the drawings, reference numbers may be reused to identify similar and/or identical elements.

### DETAILED DESCRIPTION

The present disclosure is directed to a system configured to assess structural integrity of a battery tray. Battery trays are used in various applications to support and secure battery packs. For example, battery trays are used in various vehicles, such as battery electric vehicles (BEVs), plug-in hybrid electric vehicles (PHEVs), and hybrid electric vehicles (HEVs). Battery trays are used in various non-vehicular applications as well. The present disclosure is directed systems and methods for inspecting battery trays. The battery trays may be configured for installation in a vehicle, or configured for any suitable non-vehicular application.

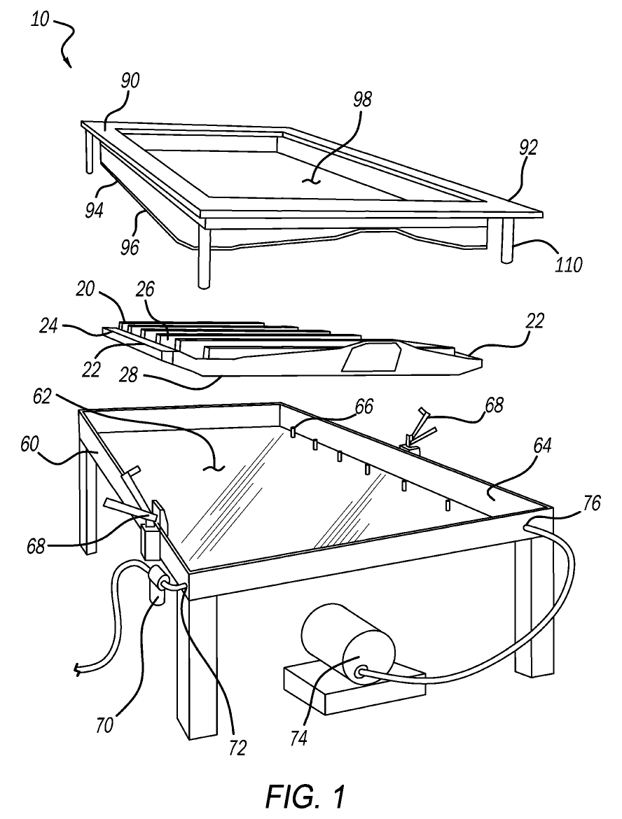

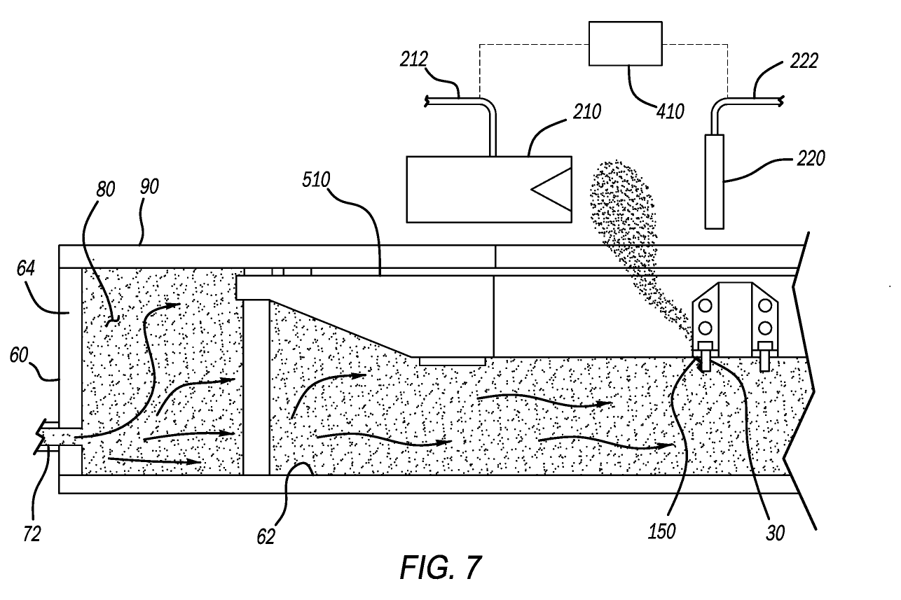

FIG. 1 illustrates an exemplary system 10 configured to assess the structural integrity of any suitable battery pack component, such as, but not limited to, a battery tray 20, a battery pack cover 510 (FIG. 7), etc. The battery tray 20 is an exemplary battery tray, which may be configured to support various types of battery cells, such as prismatic battery cells, cylindrical battery cells, etc. The battery cells are packaged in battery packs, which are mounted to the battery tray 20 in any suitable manner. The battery tray 20 may be configured for installation in any suitable vehicle, such as a BEV, PHEV, HEV, etc. The battery tray 20 may be configured for use in any suitable non-vehicular application as well.

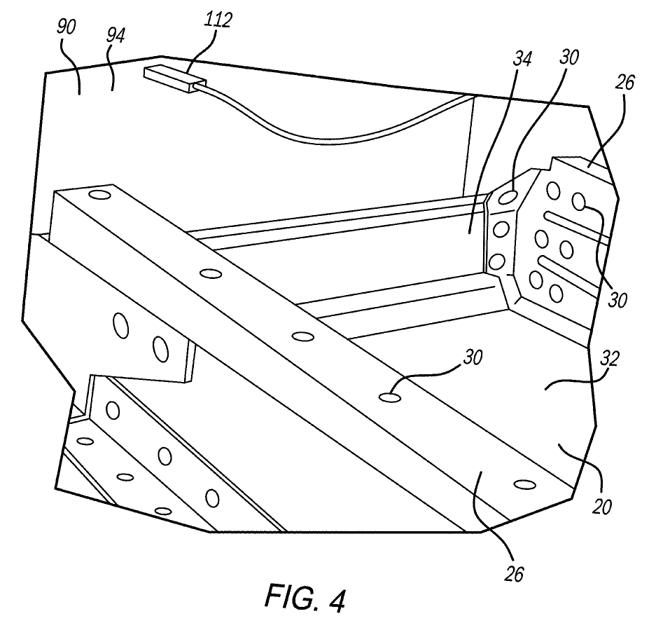

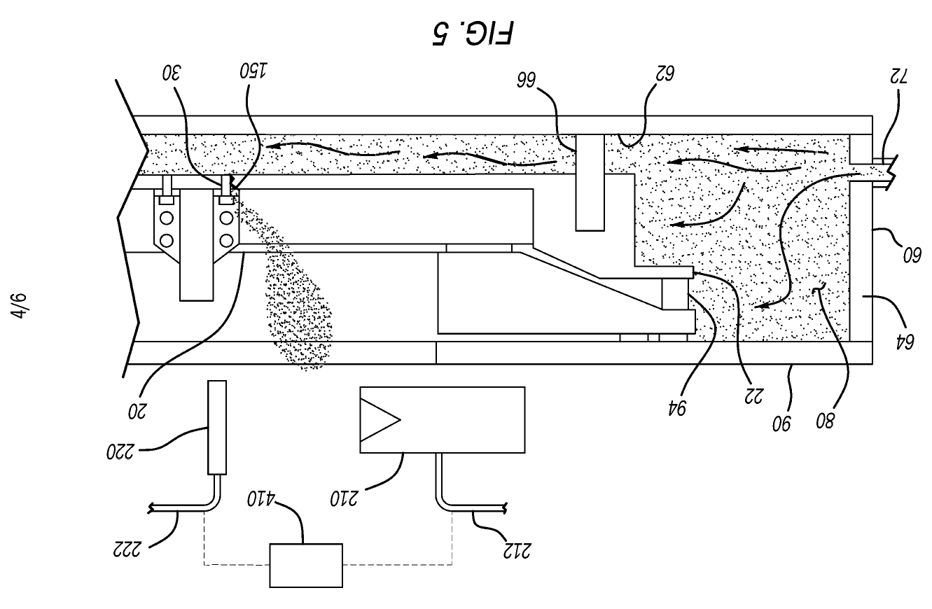

The battery tray 20 includes an outer edge 22, which extends generally about an outer periphery of the battery tray 20. An outer flange 24 of the battery tray 20 may include the outer edge. Extending across the battery tray 20 are a plurality of partition walls 26. The battery packs are arranged between the partition walls 26. The battery tray 20 further includes a bottom surface 28, which is at an outer surface of the battery tray 20. The bottom surface 28 is opposite to a base 32 of the battery tray 20. The base 32 is illustrated in FIGS. 3 and 4, for example. The battery packs are seated on the base 32.

The system 10 further includes a receptacle configured to hold the battery tray 20, such as a tub 60. The tub 60 may be configured to hold the battery tray 20 and the battery pack cover 510 individually to individually inspect the integrity thereof in accordance with the present disclosure, or configured to hold the battery tray 20 and the battery pack cover 510 simultaneously to inspect the integrity thereof simultaneously. The tub 60 includes a base 62, which may be supported above a floor surface with legs. A tub wall 64 extends around the base 62. Extending upward from the base 62 are supports 66, which are configured to cooperate with the battery tray 20. One or more clamps 68, or any other suitable retention device, may be included to clamp a cover 90 onto the tub 60 and the battery tray 20, as explained herein. Any suitable clamps 68 may be used.

The system 10 includes a pump 70, which is connected to an inlet 72 of the tub 60 with any suitable air tube, for example. The pump 70 is configured to pump any suitable trace gas into the system 10, such as carbon dioxide (CO₂), as explained herein. The gas may be less than 100% carbon dioxide, such as mixed with an inert gas such as argon, for example. Prior to pumping in the trace gas, a vacuum pump 74 is configured to draw air out of the system 10 through an outlet 76 of the tub 60. Pulling such a vacuum is optional, and thus need not be included in all applications of the present disclosure.

The cover 90 includes a frame 92, which is generally rectangular. The frame 92 is open in the middle to define a center aperture 98. The aperture 98 may also be rectangular. Extending from the frame 92 is a cover flange 94. At a distal end of the cover flange 94 is a seal 96. The cover 90 includes legs 110, which are configured to support the cover 90 on the base 62 of the tub 60.

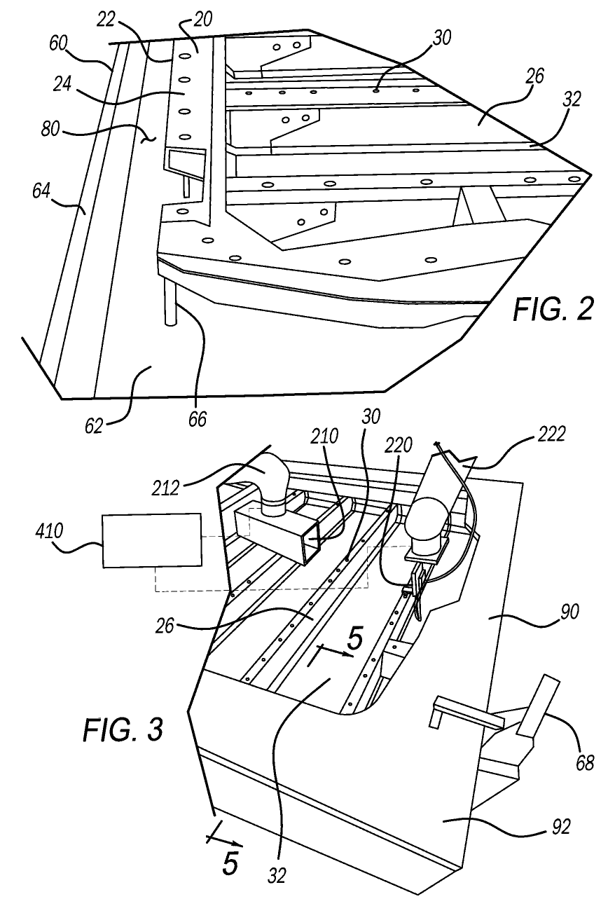

FIG. 2 illustrates the battery tray 20 seated on the base 62 of the tub 60 in cooperation with the supports 66 of the tub 60. FIG. 3 illustrates the cover 90 clamped onto the battery tray 20 and the tub 60 with the clamps 68. The cover 90 is clamped onto the tub 60 and the battery tray 20 to form a seal between the cover 90 and the tub wall 64, and a seal between the seal 96 and the outer edge 22 and/or outer flange 24 of the battery tray 20. Clamping the cover 90 onto the battery tray 20 and the tub 60 results in a reservoir 80 being defined between the tub 60, the battery tray 20, and the cover 90. The reservoir 80 may be an air-tight reservoir, or at least substantially air-tight. As illustrated in FIG. 5, for example, the reservoir 80 extends around the battery tray 20 and under the battery tray 20 between the bottom surface 28 of the battery tray 20 and the base 62 of the tub 60.

The battery tray 20 includes a plurality of fasteners 30 used in various different ways. For example, the fasteners 30 may be used to secure the partition walls 26 in place relative to the base 32 and the sidewall 34 of the battery tray 20 (see FIG. 4, for example). The fasteners 30 may be any suitable type of fastener. For example, the fasteners 30 may include mechanical fasteners (e.g., screws, nuts, bolts), weldments, etc. Irregularities at the connections made by the fasteners 30, or with the fasteners 30 themselves, may result in gas leaking out of the reservoir 80 through the irregularities. The irregularities may include, but are not limited to, cracks, holes, openings, fastener misalignment, etc.

The system 10 includes any suitable sensor 210 (FIGS. 3 and 5, for example) configured to detect leaks of the gas out of the reservoir 80. FIG. 5 illustrates such a leak 150. The leak 150 may be the result of various structural irregularities of the battery tray 20, the fasteners 30, and/or connection between the battery tray 20 and the fasteners 30. For example, the leak 150 may be the result of a crack in the battery tray 20, an incomplete coupling at the fasteners 30, or an irregularity in the fasteners 30 themselves (such as an incomplete or improper weldment).

The sensor 210 may be, or include, an infrared camera. The camera may be configured in any suitable manner to detect the leaks 150 of the gas out of the reservoir 80 and through the battery tray 20. For example, the infrared camera may include a filter configured to filter out infrared radiation that is outside of a wavelength of 4-5µm.

The sensor 210 is moved about the battery tray 20 in any suitable manner, such as with any suitable first robotic arm 212. In some configurations, such as when configured as an infrared camera, the sensor 210 is moved in tandem with a backplate 220, which may be heated. The backplate 220 is moved by a second robotic arm 222. The system 10 includes a control module 410, which is configured to operate the sensor 210, the first arm 212, and the second arm 222. The backplate 220 is configured as a radiation backplate and is configured to be heated to any suitable temperature above ambient temperature, such as 10°C-30°C above ambient temperature. The control module 410 is configured to position the sensor 210 and the backplate 220 on opposite sides of a surface of the battery tray 20 to be scanned.

Such positioning may be difficult or not possible at various areas. For example and as illustrated in FIG. 4, at an intersection between the partition wall 26 and the sidewall 34 of the battery tray 20 there may be no room to position the backplate 220. In such areas, an inner surface of the cover flange 94 may be configured to provide the functionality of the backplate 220. Specifically, a heating element 112 is connected to the cover flange 94 to heat the cover flange 94 to the same or similar temperature as the backplate 220 would be heated. For example, the heating element 112 is configured to heat the cover flange 94 to a temperature that is 10°C-30°C above ambient. In addition to being heated, the inner surface of the cover flange 94 may be painted with a dark color, such as black.

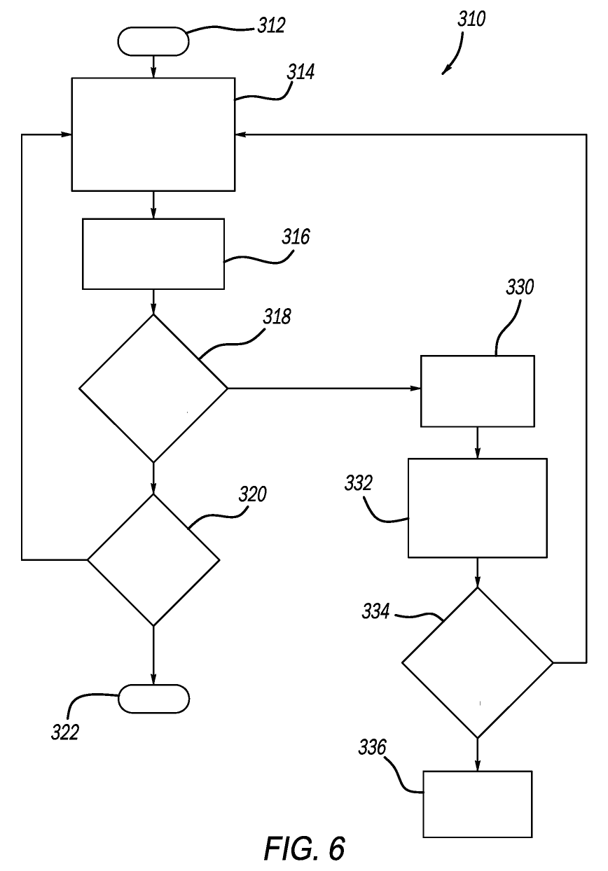

FIG. 6 illustrates an exemplary method 310 in accordance with the present disclosure for assessing the structural integrity of the battery tray 20. The method 310 may be performed by the control module 410, for example. The method 310 starts at block 312, and at block 314 the control module 410 operates the sensor 210 to execute a scan trajectory for a quadrant of the battery tray 20. The battery tray 20 may be divided into various quadrants, such as four quadrants of equal size. To execute the scan, the control module 410 is configured to move the sensor 210 (and the backplate 220) about the battery tray 20 by operating the first arm 212 and the second arm 222. At block 316, the control module 410 is configured to operate the sensor 210 to capture images as the sensor 210 is moved (i.e., moving frame images) about the battery tray 20.

The control module 410 is configured to operate the sensor 210 to capture, and optionally save, infrared images (in the wavelength of 4-5µm, for example) of the battery tray 20, including the fasteners 30 thereof. The control module 410 is configured to save the images at any suitable storage device of the control module 410 (or associated with the control module 410). The control module 410 is configured to analyze the captured infrared images to ascertain whether or not the gas of the reservoir 80 is leaking through the battery tray 20, such as through a leak 150 (FIG. 5) in the battery tray 20 and/or a fastener 30. In a non-limiting example, an image analysis module of the control module 410 examines each infrared image captured by the sensor 210 to locate and evaluate infrared waves corresponding to gas from the reservoir 80 leaking through the battery tray 20.

An image analysis module of the control module 410 may use any suitable gas cloud modeling algorithm, for example, to locate gas leaking through the battery tray 20. The control module 410 is configured to determine that the leaks 150 of the gas correspond to areas of the battery tray 20 having structural irregularities. Upon detection of the leaks 150, the control module 410 is configured to generate an alert indicating that structural integrity of the battery tray 20 may be compromised.

From block 316, the method 310 proceeds to block 318, where the control module 410 processes the scanned images captured as described above to determine whether there is a suspected leak 150 in the battery tray 20. If the control module 410 does not locate a suspected leak, the method proceeds to block 320. At block 320, the control module 410 determines whether the scan is complete, such as whether all of the predetermined quadrants of the battery tray 20 have been scanned. If the scan of the entire area of interest (e.g., all quadrants) of the battery tray 20 is complete, then the method 310 proceeds to block 322 where the method ends. Otherwise, the method 310 returns to block 314.

If at block 318 the sensor 210 identifies a suspected leak 150, the method 310 proceeds from block 318 to block 330. At block 330, the control module 410 is configured to stop the robotic arm 212 to stop the sensor 210 at the area of the suspected leak 150. The control module 410 is configured to operate the sensor 210 at block 332 to further scan the suspected leak with the sensor 210 stationary to determine whether or not an actual leak of the gas from the reservoir 80 through the battery tray 20 is present. If no leak is confirmed, then the method 310 returns to block 314. If a leak is confirmed, such as the leak 150, the test result is stored at the control module 410 or at any other suitable location. The control module 410 is configured to generate any suitable notification or alert indicating detection of the leaks 150 corresponding to structural irregularities of the battery tray 20. The present disclosure thus provides for various systems and methods (including the system 10 and the method 310) configured to enhance inspection and quality control of the battery tray 20 and any other suitable battery pack component.

The system 10 also provides for inspecting the structural integrity of a battery pack cover 510, as illustrated in FIG. 7, for example. FIG. 7 illustrates the tub 60 configured to support the battery pack cover 510 therein, and the cover 90 configured to seal against both the tub 60 and the battery pack cover 510. The battery pack cover 510, in the example illustrated, includes the fasteners 30 used in any suitable manner, such as to connect various parts of the battery pack cover 510 together. The sensor 210 is configured to detect leaks of the gas out of the reservoir 80. The leak 150 may be the result of various structural irregularities of the battery pack cover 510, the fasteners 30, and/or connection between the battery pack cover 510 and the fasteners 30. For example, the leak 150 may be the result of a crack in the battery pack cover 510, an incomplete coupling at the fasteners 30, or an irregularity in the fasteners 30 themselves (such as an incomplete or improper weldment). The control module 410 may be configured to operate the sensor 210, the first arm 212, and the second arm 222 to detect the leak 150 at the battery pack cover 510. Thus, the method 310 described above with respect to the battery tray 20 also applies to the battery pack cover 510 or any other suitable battery pack component.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

WHAT IS CLAIMED IS:

1. A system configured to assess structural integrity of a battery pack component, the system comprising:
a tub configured to receive the battery pack component therein;
a cover configured to sit on the tub and the battery pack component within the tub, and form a seal against both the tub and the battery pack component, thereby defining a reservoir between the tub, the cover, and the battery pack component;
a pump configured to pump a gas into the reservoir through an inlet at the tub; and
a sensor configured to detect a leak of the gas through the battery pack component from the reservoir, the leak corresponding to an area of the battery pack component having structural irregularities.

2. The system of claim 1, wherein the battery pack component includes at least one of a battery back tray and a battery pack cover.

3. The system of claim 1, further comprising clamps configured to clamp the cover against both the tub and the battery pack component.

4. The system of claim 1, wherein the seal is an air-tight seal formed between the cover and each of a tub wall of the tub and a battery pack flange of the battery pack component.

5. The system of claim 1, wherein the gas includes carbon dioxide.

6. The system of claim 1, further comprising a vacuum pump configured to draw air out from within the reservoir prior to pumping the gas into the reservoir.

7. The system of claim 1, wherein a portion of the reservoir is defined beneath the battery pack component between a bottom surface of the battery pack component and a base of the tub.

8. The system of claim 1, wherein sensor includes an infrared camera.

9. The system of claim 8, wherein the infrared camera includes a filter configured to block infrared radiation outside of a wavelength of 4-5µm.

10. The system of claim 8, further comprising a heating element configured to heat an inner surface of a cover flange of the cover, the inner surface painted a dark color, to configure the inner surface as a radiation backplate for the infrared camera.

11. The system of claim 8, wherein the infrared camera is mounted to a first robot arm, the system further including a heated backplate mounted to a second robot arm.

12. The system of claim 11, wherein the heated backplate is configured to be heated to within a range of 10°C-30°C above ambient temperature.

13. The system of claim 1, further comprising a control module configured to control the sensor and control a robot arm configured to move the sensor about the battery pack component to perform a moving scan of the battery pack component for the leak of the gas, and to perform a stationary scan of the battery pack component for the leak of the gas after the leak is initially identified by the moving scan.

14. A system configured to assess structural integrity of a battery pack component, the system comprising:
a tub configured to receive the battery pack component therein;
a cover configured to sit on the tub and the battery pack component seated within the tub, and form a seal against both the tub and the battery pack component, thereby defining a reservoir between the tub, the cover, and the battery pack component;
a pump configured to pump a gas into the reservoir through an inlet at the tub;
a sensor configured to detect a leak of the gas through the battery pack component from the reservoir, the leak corresponding to an area of the battery pack component having structural irregularities;
a robotic arm configured to move the sensor about the battery pack component to detect the leak; and
a control module configured to move the robotic arm and operate the sensor to perform a moving scan of the battery pack component and, upon identifying a suspected leak with the moving scan, operate the robotic arm and the sensor to perform a stationary scan of the suspected leak to determine whether the suspected leak is an actual leak of the gas through the battery pack component from the reservoir.

15. The system of claim 14, wherein:
the sensor includes an infrared camera;
the robotic arm is a first robotic arm, the system further including a second robotic arm configured to move a radiation backplate; and
the control module is further configured to move the first robotic arm in tandem with the second robotic arm so that the infrared camera faces the radiation backplate.

16. The system of claim 14, further comprising a heating element configured to heat an inner surface of a cover flange of the cover, the inner surface painted a dark color, to configure the inner surface as a radiation backplate for the sensor configured as an infrared camera.

17. The system of claim 14, wherein the battery pack component includes at least one of a battery pack tray and a battery pack cover.

18. A method for assessing structural integrity of a battery pack component, the method comprising:
positioning the battery pack component within a tub fixture;
clamping a cover onto the tub fixture and the battery pack component seated within the tub fixture to form a seal between the cover and each of the tub fixture and the battery pack component, thereby defining a reservoir between the tub fixture, the cover, and the battery pack component;
generating a vacuum that draws air out from within the reservoir;
pumping a gas into the reservoir; and
moving a robotic arm and operating a sensor to perform a moving scan of the battery pack component and, upon identifying a suspected leak in the battery pack component of gas through the battery pack component from the reservoir, operating the robotic arm and the sensor to perform a stationary scan of the suspected leak to determine whether the suspected leak is an actual leak of the gas through the battery pack component from the reservoir.

19. The method of claim 18, wherein the sensor is an infrared camera and the robotic arm is a first robotic arm, the method further comprising moving a second robotic arm holding a radiation backplate in tandem with the first robotic arm such that the infrared camera faces the radiation backplate.

20. The method of claim 18, further comprising heating an inner surface of a cover flange of the cover with a heating element, the inner surface painted a dark color, to configure the inner surface as a radiation backplate for the sensor configured as an infrared camera.
